(19) United States
(12) Patent Application Publication
(10) Pub. No.: US 2021/0009326 A1
(43) Pub. Date: Jan. 14, 2021

(54) LAMINATED FILM, PACKAGING MATERIAL, AND PACKAGE

(71) Applicant: DOW-MITSUI POLYCHEMICALS CO., LTD., Tokyo (JP)

(72) Inventors: Hidenori HASHIMOTO, Chiba (JP); Takuya OGATA, Chiba (JP)

(21) Appl. No.: 16/978,111

(22) PCT Filed: Mar. 20, 2019
(86) PCT No.: PCT/JP2019/011813

§ 371 Date: Sep. 3, 2020

(30) Foreign Application Priority Data
Mar. 27, 2018 (JP) 2018-059969

(51) Int. Cl. B65D 65/40; B32B 15/08; B32B 23/08; B32B 27/08; B32B 27/32; B32B 27/34; B32B 27/36

(52) U.S. Cl. CPC B65D 65/40; B32B 15/08; B32B 23/08; B32B 27/08; B32B 2553/00; B32B 27/34; B32B 27/36; B32B 2307/31; B32B 27/32

(57) ABSTRACT

The laminated film (10) of the present invention is a laminated film including at least a substrate layer (A) and an ionomer resin layer (B) provided on one surface of the substrate layer (A), the ionomer resin layer (B) including an ionomer of ethylene-unsaturated carboxylic acid-based copolymer (B1) . When a content of unsaturated carboxylic acid in the ethylene-unsaturated carboxylic acid-based copolymer (B2) constituting the ionomer of ethylene-unsaturated carboxylic acid-based copolymer (B1) is designated as X [mass %], and a degree of neutralization of the ionomer of ethylene-unsaturated carboxylic acid-based copolymer (B1) is designated as Y [mol %], a metal ion content represented by the formula: X×Y/100 is more than 5.0 and less than or equal to 20.0.

### TECHNICAL FIELD

The present invention relates to a laminated film, a packaging material, and a package.

### BACKGROUND ART

Regarding a laminated film for packaging, laminated films produced by bonding an ionomer resin layer formed from an ionomer resin together with a substrate film are known.

Regarding a technology relating to such a laminated film for packaging, for example, the technologies described in Patent Document 1 (Japanese Laid-Open Patent Publication No. 2000-202956) and Patent Document 2 (Japanese Laid-Open Patent Publication No. 2002-210895) may be mentioned.

Patent Document 1 describes a transversely easily tearable laminated film that substantially does not exhibit longitudinal tearability, the laminated film being a co-extruded film of an ethylene-unsaturated carboxylic acid copolymer ionomer (A) and an ethylene-α-olefin copolymer (B), which may include polyethylene at a proportion of up to 50% by weight and has a density of 870 to 940 kg/m³, wherein the transversely easily tearable laminated film has a transverse tear strength in the range of 50 to 300 N/cm.

Patent Document 2 describes a transversely easily tearable composite film having a first layer, a second layer, and a third layer laminated in this order, the first layer being formed from a linear low-density polyethylene (A), the second layer being formed from an ionomer resin (B), the third layer being formed from a linear low-density polyethylene resin (A), wherein the linear low-density polyethylene (A) forming the first layer and the third layer is an ethylene-α-olefin copolymer produced using a metallocene-based catalyst for olefin polymerization, and the linear low-density polyethylene (A) has a density (d: ASTM D1505) of 0.905 to 0.950 g/cm³ and a melt flow rate (MFR: ASTM D1238, 190° C., load 2.16 kg) of 0.5 to 4.0 g/10 min.

### RELATED DOCUMENT

### Patent Document

[Patent Document 1] Japanese Laid-Open Patent Publication No. 2000-202956

[Patent Document 2] Japanese Laid-Open Patent Publication No. 2002-210895

### SUMMARY OF THE PRESENT INVENTION

### Technical Problem

The demand for the technological level of various characteristics of laminated films for packaging is ever increasing. According to the investigation of the inventors of the present invention, it was found that the laminated films each including a substrate film and an ionomer resin layer as described in Patent Documents 1 and 2 may have poor tearability in any one or both of the MD direction and the TD direction.

The present invention was achieved in view of the above-described circumstances, and it is an object of the present invention to provide a laminated film having excellent tearability.

### Solution To Problem

The inventors of the present invention repeatedly conducted a thorough investigation in order to achieve the object described above. As a result, the inventors found that when an ionomer resin layer having the metal ion content in a particular range is formed on a substrate layer, a laminated film having excellent tearability in both the MD direction and the TD direction may be obtained, thus completing the present invention.

That is, according to the present invention, a laminated film, a packaging material, and a package as disclosed below are provided.

A laminated film, including at least:

a substrate layer (A); and

an ionomer resin layer (B) provided on one surface of the substrate layer (A) and containing an ionomer of ethylene-unsaturated carboxylic acid-based copolymer (B1),

in which when a content of unsaturated carboxylic acid in the ethylene-unsaturated carboxylic acid-based copolymer (B2) constituting the ionomer of ethylene-unsaturated carboxylic acid-based copolymer (B1) is designated as X [mass %], and a degree of neutralization of the ionomer of ethylene-unsaturated carboxylic acid-based copolymer (B1) is designated as Y [mol %], the metal ion content represented by the formula: X×Y/100 is more than 5.0 and less than or equal to 20.0.

The laminated film according to [1], in which tear strengths of the laminated film in the MD direction and the TD direction of the ionomer resin layer (B) as measured according to JIS K7128 (1998) are respectively less than or equal to 5.0 N.

The laminated film according to [1] or [2], in which a melt flow rate (MFR) of the ionomer of ethylene-unsaturated carboxylic acid-based copolymer (B1) as measured according to JIS K7210:1999 under conditions of 190° C. and a load of 2,160 g is more than or equal to 0.1 g/10 min and less than or equal to 30 g/10 min.

The laminated film according to any one of [1] to [3], in which a thickness of the ionomer resin layer (B) is 5 pm or more.

The laminated film according to any one of [1] to [4], in which the ionomer resin layer (B) is an extrusion coating processed layer.

The laminated film according to any one of [1] to [5], in which the unsaturated carboxylic acid constituting the ethylene-unsaturated carboxylic acid-based copolymer (B2) includes at least one selected from acrylic acid and methacrylic acid.

The laminated film according to any one of [1] to [6], in which a metal ion constituting the ionomer of ethylene-unsaturated carboxylic acid-based copolymer (B1) includes at least one selected from sodium ion, zinc ion, and magnesium ion.

The laminated film according to any one of [1] to [7], in which the substrate layer (A) includes at least one selected from the group consisting of a metal foil, a polyolefin film, a polyester film, a polyamide film, and a cellophane.

The laminated film according to [8], in which the substrate layer (A) includes a metal foil.

The laminated film according to any one of [1] to [9], further including a heat-sealable layer (C).

The laminated film according to [10], in which the heat-sealable layer (C) contains a polyolefin.

A packaging material including at least a layer formed by the laminated film according to any one of [1] to [11].

A package including the packaging material according to [12] and an article packaged with the packaging material

### Advantageous Effects of Invention

According to the present invention, a laminated film having excellent tearability can be provided.

### BRIEF DESCRIPTION OF THE DRAWINGS

The purpose described above as well as other purposes, features, and advantages will be further made clear by means of the suitable embodiments described below and the following drawings attached thereto.

FIG. 1 is a cross-sectional view schematically illustrating an example of the structure of a laminated film according to an embodiment of the present invention.

FIG. 2 is a cross-sectional view schematically illustrating an example of the structure of a laminated film according to an embodiment of the present invention.

### DESCRIPTION OF EMBODIMENTS

Hereinafter, embodiments of the present invention will be described using the drawings. Unless particularly stated otherwise, the expression “X to Y” for a value range represents more than or equal to X and less than or equal to Y.

1. Laminated film

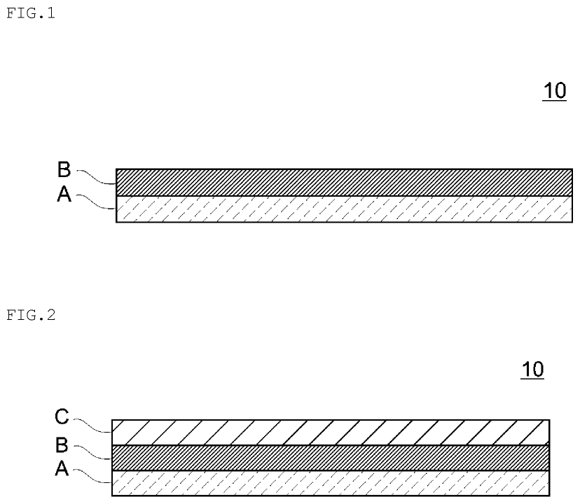

FIG. 1 is a cross-sectional view schematically illustrating an example of the structure of a laminated film 10 according to an embodiment of the present invention.

The laminated film 10 according to the present embodiment is a laminated film including at least a substrate layer (A); and an ionomer resin layer (B) that is provided on one surface of the substrate layer (A) and contains an ionomer of ethylene-unsaturated carboxylic acid-based copolymer (B1), in which when the content of the unsaturated carboxylic acid in the ethylene-unsaturated carboxylic acid copolymer (B2) constituting the ionomer of ethylene-unsaturated carboxylic acid-based copolymer (B1) is designated as X [mass %], and the degree of neutralization of the ionomer of ethylene-unsaturated carboxylic acid-based copolymer (B1) is designated as Y [mol %], the metal ion content represented by the formula: X×Y/100 is more than 5.0 and less than or equal to 20.0.

As described above, according to the investigation conducted by the inventors of the present invention, it was found that the laminated films each including a substrate film and an ionomer resin layer as described in Patent Documents 1 and 2 may have poor tearability in any one or both of the MD direction and the TD direction.

The inventors of the present invention repeatedly conducted a thorough investigation in order to achieve the object described above. As a result, the inventors found that when an ionomer resin layer (B) containing an ionomer of ethylene-unsaturated carboxylic acid-based copolymer (B1) having a metal ion content represented by the formula: X×Y/100 in the range of more than 5.0 and less than or equal to 20.0, is formed on one surface of the substrate layer (A), a laminated film 10 having excellent tearability in both the MD direction and the TD direction is obtained.

That is, the laminated film 10 according to the present embodiment can acquire satisfactory tearability by having the layer configuration described above.

The laminated film 10 according to the present embodiment is preferably such that the tear strengths in the MD direction and the TD direction of the ionomer resin layer (B) as measured according to JIS K7128 (1998) are respectively 5.0 N or less. The tear strength in the MD direction is more preferably 4.0 N or less, and even more preferably less than 3.5 N. The tear strength in the TD direction is more preferably 4.5 N or less. The lower limit is not particularly limited; however, it is preferable that the tear strengths in the MD direction and the TD direction are both 0.1 N or more. Thereby, the tearability of the laminated film 10 according to the present embodiment can be further improved.

Hereinafter, the various layers constituting the laminated film 10 according to the present embodiment will be explained.

<Substrate layer (A)>

The substrate layer (A) is a layer provided for the purpose of improving the handleability, mechanical characteristics, and characteristics such as electrical conductivity, thermal insulation properties, heat resistance, and barrier properties of the laminated film 10. Examples of the substrate layer (A) include a metal foil (copper foil, aluminum foil, or the like), a polyamide film, a polypropylene film, a polyester film, a polyimide film, a polyvinylidene chloride film, an ethylene-vinyl acetate copolymer film, an aluminum deposited film, paper, and a cellophane. These may be used singly, or two or more kinds thereof may be used in combination. These may be uniaxially or biaxially stretched products.

Among these, from the viewpoint of having excellent mechanical strength, pinhole resistance, and the like, at least one selected from the group consisting of a metal foil, a polyolefin film, a polyester film, a polyamide film, and a cellophane is preferred. The substrate layer (A) maybe a single layer, or may be a laminate of two or more kinds of layers.

Furthermore, from the viewpoint of improving the barrier properties of the laminated film 10, it is preferable that the substrate layer (A) includes a metal foil. Examples of the metal foil include an aluminum foil and a copper foil.

From the viewpoint of obtaining satisfactory film characteristics, the thickness of the substrate layer (A) is preferably more than or equal to 1 μm and less than or equal to 200 μm, more preferably more than or equal to 3 μm and less than or equal to 100 μm, and even more preferably more than or equal to 5 μm and less than or equal to 80 μm.

The substrate layer (A) maybe subjected to a surface treatment in order to ameliorate the adhesiveness with other layers. Specifically, the substrate layer (A) may be subjected to a corona treatment, a plasma treatment, an anchor coating treatment, and a primer coating treatment.

<Ionomer resin layer (B)>

The ionomer resin layer (B) according to the present embodiment is formed using a resin composition including an ionomer of ethylene-unsaturated carboxylic acid-based copolymer (B1).

The content of the ionomer of ethylene-unsaturated carboxylic acid-based copolymer (B1) in the ionomer resin layer (B) is, from the viewpoint of further enhancing the tearability of the laminated film 10, preferably 70% by mass or more, more preferably 80% by mass or more, even more preferably 90% by mass or more, and particularly preferably 95% by mass or more, when the total amount of the ionomer resin layer (B) is designated as 100% by mass. The upper limit of the content of the ionomer of ethylene-unsaturated carboxylic acid-based copolymer (B1) is not particularly limited; however, the upper limit is, for example, 100% by mass or less.

In regard to the ionomer of ethylene-unsaturated carboxylic acid-based copolymer (B1), the metal ion content represented by the formula: X×Y/100 is more than 5.0 and less than or equal to 20.0. However, from the viewpoint of further enhancing tearability, the metal ion content is preferably 6.0 or more, and from the viewpoint of enhancing the film-forming properties of the ionomer resin layer (B), the metal ion content is preferably 18.0 or less, more preferably 15.0 or less, even more preferably 12.0 or less, and particularly preferably 10.0 or less.

The thickness of the ionomer resin layer (B) is, for example, more than or equal to 1 μm and less than or equal to 100 μm, preferably more than or equal to 3 μm and less than or equal to 80 μm, and more preferably more than or equal to 5 μm and less than or equal to 40 μm.

Furthermore, from the viewpoint of improving the extrusion coatability of the ionomer resin layer (B), the thickness of the ionomer resin layer (B) is preferably 5 μm or more, and more preferably 10 μm or more. From the viewpoint of further improving the tearability of the laminated film 10, the thickness of the ionomer resin layer (B) is preferably 40 μm or less, more preferably 30 μm or less, and even more preferably 25 μm or less.

The ethylene-unsaturated carboxylic acid-based copolymer (B2), which serves as a base resin for the ionomer of ethylene-unsaturated carboxylic acid-based copolymer (B1), is a polymer obtained by copolymerizing at least ethylene and a monomer selected from unsaturated carboxylic acids as copolymerization components, and if necessary, a monomer other than ethylene and an unsaturated carboxylic acid-based monomer may be further copolymerized. The copolymer may be any one of a block copolymer, a random copolymer, and a graft copolymer; however, when productivity is considered, it is preferable to use a binary random copolymer, a ternary random copolymer, a graft copolymer of a binary random copolymer, or a graft copolymer of a ternary random copolymer, and it is more preferable to use a binary random copolymer or a ternary random copolymer.

It is preferable that the ethylene-unsaturated carboxylic acid-based copolymer (B2) is at least one selected from the group consisting of an ethylene-unsaturated carboxylic acid binary copolymer and an ethylene-unsaturated carboxylic acid alkyl ester-unsaturated carboxylic acid ternary copolymer. Examples of the unsaturated carboxylic acid include unsaturated carboxylic acids having 4 to 8 carbon atoms, or half esters thereof, such as acrylic acid, methacrylic acid, ethacrylic acid, itaconic acid, itaconic anhydride, fumaric acid, crotonic acid, maleic acid, maleic anhydride, a maleic acid monoester (monomethyl maleate, monoethyl maleate, or the like), and a maleic anhydride monoester (monomethyl maleic anhydride, monoethyl maleic anhydride, or the like).

Among these, it is preferable, from the viewpoint of the productivity for the ethylene-unsaturated carboxylic acid-based copolymer (B2) or the like, that the unsaturated carboxylic acid includes at least one selected from acrylic acid and methacrylic acid. These unsaturated carboxylic acids may be used singly, or two or more kinds thereof may be used in combination.

The ethylene-unsaturated carboxylic acid-based copolymer (B2) is a copolymer obtained by copolymerizing at least ethylene with an unsaturated carboxylic acid, and may be a multi-component copolymer such as a ternary or higher copolymer having a third copolymerization component further copolymerized thereinto.

In regard to the multi-component copolymer, in addition to ethylene and (meth) acrylic acid that can be copolymerized with this ethylene, an unsaturated carboxylic acid ester (for example, a (meth) acrylic acid alkyl ester such as methyl acrylate, ethyl acrylate, isobutyl acrylate, n-butyl acrylate, isooctyl acrylate, methyl methacrylate, ethyl methacrylate, isobutyl methacrylate, dimethyl maleate, or diethyl maleate), a vinyl ester (for example, vinyl acetate or vinyl propionate), an unsaturated hydrocarbon (for example, propylene, butane, 1,3-butadiene, pentene, 1,3-pentadiene, or 1-hexene), an oxide such as vinyl sulfate or vinyl nitrate, a halogen compound (for example, vinyl chloride or vinyl fluoride), a vinyl group-containing primary or secondary amine compound, carbon monoxide, sulfur dioxide, or the like may be copolymerized as a third copolymerization component into the copolymer.

Among these, the third copolymerization component is preferably an unsaturated carboxylic acid ester, and more preferably a (meth) acrylic acid alkyl ester (a preferred number of carbon atoms of the alkyl moiety is 1 to 4).

The content proportion of a constituent unit derived from the third copolymerization component in the ethylene-(meth)acrylic acid-based copolymer is preferably in the range of 25% by mass or less.

When the content proportion of the constituent unit derived from the third copolymerization component is less than or equal to the above-mentioned upper limit, it is preferable from the viewpoint of production and mixing.

In regard to the ethylene-unsaturated carboxylic acid-based copolymer (B2) according to the present embodiment, the content of a constituent unit derived from ethylene is, when the amount of all the constituent units of the ethylene-unsaturated carboxylic acid-based copolymer (B2) is designated as 100% by mass, preferably more than or equal to 65% by mass and less than or equal to 95% by mass, more preferably more than or equal to 75% by mass and less than or equal to 93% by mass, and even more preferably more than or equal to 80% by mass and less than or equal to 92% by mass.

In regard to the ethylene-unsaturated carboxylic acid-based copolymer (B2) according to the present embodiment, the content of a constituent unit derived from an unsaturated carboxylic acid (that is, content X of the unsaturated carboxylic acid) is, when the amount of all the constituent units of the ethylene-unsaturated carboxylic acid-based copolymer (B2) is designated as 100% by mass, preferably more than or equal to 5% by mass and less than or equal to 35% by mass, more preferably more than or equal to 7% by mass and less than or equal to 25% by mass, and even more preferably more than or equal to 8% by mass and less than or equal to 20% by mass. Here, the content (X) of the unsaturated carboxylic acid in the ethylene-unsaturated carboxylic acid-based copolymer (B2) can be measured by, for example, Fourier transform infrared spectroscopy (FT-IR).

Examples of the metal ion that constitutes the ionomer of ethylene-unsaturated carboxylic acid-based copolymer (B1) according to the present embodiment include alkali metal ions such as lithium ion, potassium ion, and sodium ion; and polyvalent metal ions such as calcium ion, magnesium ion, zinc ion, aluminum ion, and barium ion. These metal ions maybe used singly, or two or more kinds thereof may be used in combination.

Among these, it is preferable that the metal ion includes at least one selected from sodium ion, zinc ion, and magnesium ion.

The degree of neutralization of the ionomer of ethylene-unsaturated carboxylic acid-based copolymer (B1) according to the present embodiment is not particularly limited; however, from the viewpoint of further enhancing processability or moldability, the degree of neutralization is preferably 95 mol % or less, more preferably 90 mol % or less, even more preferably 85 mol % or less, and particularly preferably 80 mol % or less. Furthermore, the degree of neutralization of the ionomer of ethylene-unsaturated carboxylic acid-based copolymer (B1) according to the present embodiment is not particularly limited; however, from the viewpoint of further enhancing the tearability, heat resistance, and processability of the laminated film 10, the degree of neutralization is preferably 5 mol % or more, more preferably 10 mol % or more, even more preferably 15 mol % or more, and particularly preferably 20 mol % or more.

Here, the degree of neutralization of the ionomer of ethylene-unsaturated carboxylic acid-based copolymer (B1) can be measured by, for example, an incineration residue analysis method.

The method for producing the ionomer of ethylene-unsaturated carboxylic acid-based copolymer (B1) is not particularly limited, and the ionomer can be produced by any known method. Furthermore, a commercially available product may be used for the ionomer of ethylene-unsaturated carboxylic acid-based copolymer (B1).

According to the present embodiment, the melt flow rate (MFR) of the ionomer of ethylene-unsaturated carboxylic acid-based copolymer (B1) as measured according to JIS K7210:1999 under the conditions of 190° C. and a load of 2,160 g, is preferably more than or equal to 0.1 g/10 min and less than or equal to 30 g/10, more preferably more than or equal to 0.3 g/10 min and less than or equal to 15 g/10 min, and particularly preferably more than or equal to 0.5 g/10 min and less than or equal to 10 g/10 min. When the MFR has a value more than or equal to the above-mentioned lower limit, the interlayer adhesiveness between the substrate layer (A) and the ionomer resin layer (B), or the interlayer adhesiveness between the heat-sealable layer (C) that will be described below and the ionomer resin layer (B) becomes more satisfactory. As a result, the tearability of the laminated film 10 can be further improved. As the MFR has a value less than or equal to the above-mentioned upper limit, stable extrusion coating processing molding with high accuracy is enabled.

In the ionomer resin layer (B), a component other than the ionomer of ethylene-unsaturated carboxylic acid-based copolymer (B1) can be incorporated to the extent that does not impair the purpose of the present invention. There are no particular limitations on the other component; however, examples include a plasticizer, an oxidation inhibitor, an ultraviolet absorber, an antistatic agent, a surfactant, a coloring agent, a photostabilizer, a foaming agent, a lubricating agent, a nucleating agent, a crystallization accelerator, a crystallization retarder, a catalyst deactivator, a thermoplastic resin other than the ionomer of ethylene-unsaturated carboxylic acid-based copolymer (B1), a thermosetting resin, an inorganic filler, an organic filler, an impact resistance improver, a slipping agent, a crosslinking agent, a crosslinking aid, a tackifier, a silane coupling agent, a processing aid, a mold releasing gent, a hydrolysis inhibitor, a heat-resistant stabilizer, an antiblocking agent, an antifogging agent, a flame retardant, a flame retardant aid, a light diffusing agent, an antibacterial agent, an antifungal agent, a dispersant, and other resins. The other components may be used singly, or two or more kinds thereof may be used in combination.

<Heat-Sealable Layer (C)>

FIG. 2 is a cross-sectional view schematically illustrating an example of the structure of the laminated film 10 according to an embodiment of the present invention.

The laminated film 10 according to the present embodiment may further include a heat-sealable layer (C) in order to impart heat-sealability to the laminated film 10.

It is preferable that, as shown in FIG. 2, the heat-sealable layer (C) is provided on a surface of the ionomer resin layer (B), the surface being on the opposite side of the surface where the substrate layer (A) is provided.

The heat-sealable layer (C) is a layer for imparting heat-sealability to the laminated film 10 according to the present embodiment, and the heat-sealable layer (C) contains, for example, a thermoplastic resin (C1).

The thickness of the heat-sealable layer (C) is, for example, more than or equal to 1 μm and less than or equal to 300 μm, preferably more than or equal to 5 μm and less than or equal to 200 μm, and more preferably more than or equal to 10 μm and less than or equal to 150 μm.

Examples of the thermoplastic resin (C1) according to the present embodiment include polyethylenes such as a high-density polyethylene, a high-pressure low-density polyethylene, a low-density polyethylene (LDPE), and a linear low-density polyethylene (LLDPE); and polyolefins such as an ethylene-unsaturated carboxylic acid-based copolymer, an ethylene-vinyl acetate copolymer (EVA), an ethylene-α-olefin copolymer elastomer, a polypropylene, a propylene-based copolymer (copolymer of propylene and an α-olefin other than propylene), a polybutene, and other olefin-based (co)polymers, and polymer blends of these. Examples of the α-olefin include propylene, 1-butene, 1-pentene, 1-hexene, 1-octene, 1-decene, 1-dodecene, and 4-methyl-l-pentene.

Among these, from the viewpoint of having excellent heat-sealability, it is preferable that the thermoplastic resin (C1) includes a polyolefin, and it is more preferable that the thermoplastic resin (C1) includes at least one selected from the group consisting of a low-density polyethylene (LDPE), a linear low-density polyethylene (LLDPE), an ethylene-α-olefin copolymer elastomer, polypropylene, and a propylene-based copolymer (copolymer of propylene and an α-olefin other than propylene).

The content of the thermoplastic resin (C1) in the heat-sealable layer (C) according to the present embodiment is, when the total amount of the heat-sealable layer (C) is designated as 100% by mass, preferably more than or equal to 50% by mass and less than or equal to 100% by mass, more preferably more than or equal to 70% by mass and less than or equal to 100% by mass, even more preferably more than or equal to 90% by mass and less than or equal to 100% by mass, and particularly preferably more than or equal to 95% by mass and less than or equal to 100% by mass. Thereby, the balance between the adhesiveness between the heat-sealable layer (C) and the ionomer resin layer (B), heat-sealability, and the like can be further improved.

In the heat-sealable layer (C) according to the present embodiment, a component other than the thermoplastic resin (C1) can be incorporated to the extent that does not impair the purpose of the present invention. The other component is not particularly limited; however, examples include a plasticizer, an oxidation inhibitor, an ultraviolet absorber, an antistatic agent, a surfactant, a coloring agent, a photostabilizer, a foaming agent, a lubricating agent, a nucleating agent, a crystallization accelerator, a crystallization retarder, a catalyst deactivator, a thermoplastic resin other than the thermoplastic resin (C1), a thermosetting resin, an inorganic filler, an organic filler, an impact resistance improver, a slipping agent, a crosslinking agent, a crosslinking aid, a tackifier, a silane coupling agent, a processing aid, a mold releasing agent, a hydrolysis inhibitor, a heat-resistant stabilizer, an antiblocking agent, an antifogging agent, a flame retardant, a flame retardant aid, a light diffusing agent, an antibacterial agent, an antifungal agent, a dispersant, and other resins. The other components may be used singly, or two or more kinds thereof may be used in combination.

<Other Layer>

The laminated film 10 according to the present embodiment may be configured to include only two layers, namely, the substrate layer (A) and the ionomer resin layer (B), or may be configured to include only three layers, namely, a substrate layer (A), an ionomer resin layer (B), and a heat-sealable layer (C). From the viewpoint of imparting various functions to the laminated film 10, the laminated film 10 may have a layer other than the three layers (hereinafter, also referred to as other layer) . Examples of the other layer include a foamed layer, a metal layer, an inorganic layer, a gas barrier layer, a hard coat layer, an adhesive layer, an antireflective layer, an antifouling layer, and an anchor coat layer. The other layers may be used singly, or two or more layers may be used in combination.

<Use applications>

The laminated film 10 according to the present embodiment can be suitably used as a packaging material used for packaging, for example, food products, pharmaceutical products, industrial goods, daily goods, and cosmetic products, and the laminated film 10 can be used particularly suitably as a food packaging material.

2. Method for Producing Laminated Film

It is preferable that the method for producing the laminated film 10 according to the present embodiment includes an extrusion step of performing extrusion coating of a resin composition including an ionomer of ethylene-unsaturated carboxylic acid-based copolymer (B1) on a substrate layer (A) and thereby forming an ionomer resin layer (B) on the substrate layer (A) . That is, it is preferable that the ionomer resin layer (B) of the laminated film 10 according to the present embodiment is an extrusion coating processed layer formed according to an extrusion coating method.

When an extrusion coating method is used, the resin temperature at the time of molding can be increased as compared to other film-forming methods, and it becomes possible to coat the substrate layer (A) with a resin composition including an ionomer of ethylene-unsaturated carboxylic acid-based copolymer (B1) in a molten state.

That is, according to the method for producing the laminated film 10 according to the present embodiment, an ionomer resin layer (B) can be formed on a substrate layer (A) stably with high accuracy.

The molding apparatus and molding conditions for the extrusion step are not particularly limited, and conventionally known molding apparatuses and molding conditions can be employed. Regarding the molding apparatus, a T-die extruder or the like can be used. Furthermore, regarding the molding conditions, the molding conditions used for any known extrusion coating method can be employed.

In the method for producing the laminated film 10 according to the present embodiment, the extrusion coating temperature for the extrusion step is not particularly limited because the extrusion coating temperature is set as appropriate depending on the type or blend of the ionomer of ethylene-unsaturated carboxylic acid-based copolymer (B1). However, from the viewpoint of obtaining satisfactory film-forming properties, the extrusion coating temperature is preferably 200° C. or higher, more preferably 250° C. or higher, and particularly preferably 280° C. or higher.

The upper limit of the extrusion coating temperature for the extrusion step is not particularly limited; however, the extrusion coating temperature is, for example, 350° C. or lower.

3. Packaging Material

The packaging material according to the present embodiment includes at least a layer formed by the laminated film 10 according to the present embodiment. Furthermore, the packaging material according to the present embodiment may use the laminated film 10 according to the present embodiment in some part, or may use the laminated film 10 according to the present embodiment in the entirety of the packaging material.

The shape of the packaging material according to the present embodiment is not particularly limited; however, examples include shapes such as a sheet-like shape, a film-like shape, and a bag-like shape.

The bag-like form is not particularly limited; however, examples include a three-way bag, a four-way bag, a pillow bag, a gusseted bag, and a stick bag.

The packaging material according to the present embodiment can be suitably used as a packaging material used for packaging, for example, food products, pharmaceutical products, industrial goods, daily goods, and cosmetic products, and the packaging material can be used particularly suitably as a food packaging material.

4. Package

The package according to the present embodiment includes the packaging material according to the present embodiment and an article packaged using the packaging material.

Examples of the article include food products, pharmaceutical products, industrial goods, and daily goods.

Thus, embodiments of the present invention have been described with reference to the drawings; however, these are only examples of the present invention, and various configurations other than those described above may also be employed.

### EXAMPLES

Hereinafter, the present invention will be specifically described based on Examples; however, the present invention is not intended to be limited to these Examples.

The details of the materials used for the production of the laminated film are as follows.

<Substrate layer (A)>

Substrate layer 1: PET/LDPE/AL (laminated film of a polyethylene terephthalate film (thickness: 12 μm) coated with an anchor coating agent, a low-density polyethylene film (MFR: 7.2 g/10 min, density 917 kg/m³, and thickness: 15 μm), and an AL foil (thickness: 7 μm))

<Resin layer (B)>

(Ionomer of Ethylene-Unsaturated Carboxylic Acid-Based Copolymer (B1))

10-1: Ionomer of ethylene-methacrylic acid copolymer (ethylene content: 90 mass %, methacrylic acid content: 10 mass %, metal ion: zinc, degree of neutralization: 60 mol %, MFR: 1.8 g/10 min) 10-2: Ionomer of ethylene-methacrylic acid copolymer (ethylene content: 90 mass %, methacrylic acid content: 10 mass %, metal ion: zinc, degree of neutralization: 73 mol %, MFR: 1.0 g/10 min) 10-3: Ionomer of ethylene-methacrylic acid copolymer (ethylene content: 85 mass %, methacrylic acid content: 15 mass %, metal ion: zinc, degree of neutralization: 59 mol %, MFR: 0.9 g/10 min) 10-4: Ionomer of ethylene-methacrylic acid copolymer (ethylene content: 85 mass %, methacrylic acid content: 15 mass %, metal ion: sodium, degree of neutralization: 54 mol %, MFR: 0.9 g/10 min) 10-5: Ionomer of ethylene-methacrylic acid copolymer (ethylene content: 85 mass %, methacrylic acid content: 15 mass %, metal ion: zinc, degree of neutralization: 23 mol %, MFR: 5.0 g/10 min) 10-6: Ionomer of ethylene-methacrylic acid copolymer (ethylene content: 90 mass %, methacrylic acid content: 10 mass %, metal ion: sodium, degree of neutralization: 50 mol %, MFR: 1.3 g/10 min) 10-7: Ionomer (product name: HIMILAN 1601, manufactured by DuPont-Mitsui Polychemicals Co., Ltd.)

(Low-Density Polyethylene)

LDPE1 (low-density polyethylene, MFR: 7.2 g/10 min, density 917 kg/m³)

<Heat-Sealable Layer (C)>

LLDPE1 (linear low-density polyethylene film, manufactured by Mitsui Chemicals Tohcello, Inc., product name: TUX-TCS)

LLDPE2 (linear low-density polyethylene film, manufactured by Mitsui Chemicals Tohcello, Inc., product name: TUX-HC)

LLDPE3 (linear low-density polyethylene film, manufactured by Mitsui Chemicals Tohcello, Inc., product name: TUX-MCS)

LLDPE4 (linear low-density polyethylene film, manufactured by Mitsui Chemicals Tohcello, Inc., product name: TUX-VCS)

LLDPE5 (linear low-density polyethylene film, manufactured by Tamapoly Co., Ltd., product name: LC-2, easy tearability-imparted type)

### Examples 1 to 8, Comparative Examples 1 to 4, and Reference Example 1

The ionomer of ethylene-unsaturated carboxylic acid-based copolymer (B1) or low-density polyethylene shown in Table 1 was extrusion coated between the Al foil of the substrate layer (A) and the heat-sealable layer (C), and thereby a resin layer (B) (ionomer resin layer (B) or low-density polyethylene layer) was formed on the substrate layer (A). Thus, laminated films having the layer configurations shown in Table 1 were respectively obtained. The conditions for extrusion coating were as follows.

Extruder: 65 mmϕ extruder (L/D=28)

Extrusion coating temperature (temperature under the die): 300° C., extrusion coating rate: 80 m/min, air gap: 110 mm

The following evaluations were respectively carried out for the laminated films thus obtained. The results thus obtained are respectively presented in Table 1.

<Evaluation of Easy Tearability>

(1) Evaluation by Tactile Sensation

A laminated film thus obtained was folded in half, and a notch of 5 mm was inserted into the folded part. Next, the ease of tearing at the time of cutting the laminated film back and forth with hands by means of the notch was judged by performing a comparative assessment by three panelists according to the following criteria and rating. Here, the flow direction (MD) and a perpendicular direction (TD) intersecting the flow direction of the ionomer resin layer (B) at the time of production of the laminated film were evaluated.

A: The film is easily torn off, or the film stretches slightly but is torn off.

B: The film is torn off with difficulties or not torn off, or the film stretches significantly and then is torn off.

(2) Quantitative Evaluation

The tear strengths of a laminated film in the MD direction and the TD direction were measured according to JIS K7128 (1998) under the conditions of the standard state (23° C., 50% RH) and a tensile rate of 200 mm/min, and tearability of the laminated film was evaluated. In Comparative Examples 1 to 4 and Reference Example 1, since the tear strength in the TD direction was higher than 5.0 N, the tear strength in the MD direction was not measured.

The tearability was determined to be “A” by the above-mentioned tactile sensation, and a case in which the tear strength was 5.0 N or less in both the MD direction and the TD direction was considered to be satisfactory.

TABLE 1

| | | Resin layer (B) | | | | | | |
|---|---|---|---|---|---|---|---|---|
| | | | | | | Content of | | |
| | | | Metal | Metal | | methacrylic | Degree of metal | |
| | Substrate | Resin | ion | ion | MFR | acid | neutralization | Thickness |
| | layer (A) | type | content | type | g/10 min | mass % | mol % | μm |
| Example 1 | PET/LDPE/Al | IO-1 | 6.0 | Zn | 2 | 10 | 60 | 15 |
| Example 2 | PET/LDPE/Al | IO-2 | 7.3 | Zn | 1 | 10 | 73 | 15 |
| Example 3 | PET/LDPE/Al | IO-3 | 8.8 | Zn | 1 | 15 | 59 | 15 |
| Example 4 | PET/LDPE/Al | IO-4 | 8.1 | Na | 1 | 15 | 54 | 15 |
| Example 5 | PET/LDPE/Al | IO-2 | 7.3 | Zn | 1 | 10 | 73 | 15 |
| Example 6 | PET/LDPE/Al | IO-2 | 7.3 | Zn | 1 | 10 | 73 | 15 |
| Example 7 | PET/LDPE/Al | IO-2 | 7.3 | Zn | 1 | 10 | 73 | 15 |
| Example 8 | PET/LDPE/Al | IO-2 | 7.3 | Zn | 1 | 10 | 73 | 15 |
| Comparative | PET/LDPE/Al | LDPE1 | — | — | — | — | — | 20 |
| Example 1 | | | | | | | | |
| Comparative | PET/LDPE/Al | LDPE1 | — | — | — | — | — | 20 |
| Example 2 | | | | | | | | |
| Comparative | PET/LDPE/Al | IO-5 | 3.5 | Zn | 5 | 15 | 23 | 15 |
| Example 3 | | | | | | | | |
| Comparative | PET/LDPE/Al | IO-6 | 5.0 | Na | 1 | 10 | 50 | 15 |
| Example 4 | | | | | | | | |

| | | | |
|---|---|---|---|
| Reference | PET/LDPE/Al | IO-7 | 15 |
| Example 1 | | | |

| | | | Evaluation of easy tearability | | | |
|---|---|---|---|---|---|---|
| | Heat-sealable | | | | Evaluation of tactile | |
| | layer (C) | | Tear strength (N) | | sensation | |
| | Resin | Thickness | MD | TD | MD | TD |
| | type | [μm] | direction | direction | direction | direction |
| Example 1 | LLDPE1 | 30 | 0.6 | 4.5 | A | A |
| Example 2 | LLDPE1 | 30 | 0.4 | 0.5 | A | A |
| Example 3 | LLDPE1 | 30 | 0.7 | 0.8 | A | A |
| Example 4 | LLDPE1 | 30 | 1.8 | 4.5 | A | A |
| Example 5 | LLDPE2 | 30 | 2.5 | 4.4 | A | A |
| Example 6 | LLDPE3 | 30 | 1.9 | 2.6 | A | A |
| Example 7 | LLDPE4 | 30 | 0.4 | 0.6 | A | A |
| Example 8 | LLDPE4 | 60 | 3.4 | 4.1 | A | A |
| Comparative | LLDPE1 | 30 | Not | 5.7 | B | B |
| Example 1 | | | measured | | | |
| Comparative | LLDPE5 | 30 | Not | 10.1 | A | B |
| Example 2 | | | measured | | | |
| Comparative | LLDPE1 | 30 | Not | 8.2 | A | B |
| Example 3 | | | measured | | | |
| Comparative | LLDPE1 | 30 | Not | 8.5 | B | B |
| Example 4 | | | measured | | | |
| Reference | LLDPE1 | 30 | Not | 8.0 or | B | B |
| Example 1 | | | measured | higher | | |

The laminated films of Examples 1 to 8 had excellent tearability in both the MD direction and the TD direction. In contrast, the laminated films of Comparative Examples 1 to 4 and Reference Example 1 had poor tearability in the TD direction.

This application claims priority based on Japanese Patent Application No. 2018-059969, filed on March 27, 2018, the entire disclosure of which is incorporated herein by reference.

1. A laminated film comprising at least:
a substrate film (A); and
an ionomer resin layer (B) provided on one surface of the substrate layer (A), the ionomer resin layer (B) including an ionomer of ethylene-unsaturated carboxylic acid-based copolymer (B1),
wherein when a content of unsaturated carboxylic acid in the ethylene-unsaturated carboxylic acid-based copolymer (B2) constituting the ionomer of ethylene-unsaturated carboxylic acid-based copolymer (B1) is designated as X [mass %], and a degree of neutralization of the ionomer of ethylene-unsaturated carboxylic acid-based copolymer (B1) is designated as Y [mol %],
a metal ion content represented by the formula: X×Y/100 is more than 5.0 and less than or equal to 20.0.

2. The laminated film according to claim 1, wherein tear strengths of the laminated film in the MD direction and the TD direction of the ionomer resin layer (B) as measured according to JIS K7128 (1998) are respectively 5.0 N or less.

3. The laminated film according to claim 1,
wherein a melt flow rate (MFR) of the ionomer of ethylene-unsaturated carboxylic acid-based copolymer (B1) as measured according to JIS K7210:1999 under conditions of 190° C. and a load of 2,160 g is more than or equal to 0.1 g/10 minutes and less than

4. The laminated film according to claim 1,
wherein a thickness of the ionomer resin layer (B) is 5 μm or more.

5. The laminated film according to claim 1,
wherein the ionomer resin layer (B) is an extrusion coating processed layer.

6. The laminated film according to claim 1,
wherein the unsaturated carboxylic acid constituting the ethylene-unsaturated carboxylic acid-based copolymer (B2) includes at least one selected from acrylic acid and methacrylic acid.

7. The laminated film according to claim 1,
wherein a metal ion constituting the ionomer of ethylene-unsaturated carboxylic acid-based copolymer (B1) includes at least one selected from sodium ion, zinc ion, and magnesium ion.

8. The laminated film according to claim 1,
wherein the substrate layer (A) includes at least one selected from the group consisting of a metal foil, a polyolefin film, a polyester film, a polyamide film, and a cellophane.

9. The laminated film according to claim 8,
wherein the substrate layer (A) includes a metal foil.

10. The laminated film according to claim 1, further comprising a heat-sealable layer (C).

11. The laminated film according to claim 10,

12. A packaging material comprising at least a layer formed from the laminated film according to claim 1.

13. A package comprising the packaging material according to claim 12 and an article packaged with the packaging material.
